(19) United States
(12) Patent Application Publication
(10) Pub. No.: US 2007/0046461 A1
(43) Pub. Date: Mar. 1, 2007

(54) Dentally mounted RFID security device and method of using the same

(76) Inventor: Reza Radmand, Los Angeles, CA (US)

Correspondence Address: Daniel L. Dawes;MYERS DAWES ANDRAS AND SHERMAN LLP, Suite 1150, 19900 MacArthur Boulevard, Irvine, CA, 92612, US

(21) Appl. No.: 11/508,784

(22) Filed: Aug. 23, 2006

Related U.S. Application Data
(60) Provisional application No. 60/711,151, filed on Aug. 24, 2005.

(51) Int. Cl. H04Q 7/00

(52) U.S. Cl. 340/539.13

(57) ABSTRACT

An apparatus and method for tracking a subject comprises an RFID chip attached to a tooth of the subject and a transceiver in at least periodic communication with the RFID chip. The RFID chip is attached to a buccal surface of the tooth by dental adhesive or is attached to the tooth by disposition within a cavity defined in the tooth. The apparatus further comprises a tracking system coupled to the transceiver to generate a warning alarm, when the subject goes beyond the specified radius.

### RELATED APPLICATIONS

The present application is related to U.S. Provisional Patent Application Ser. No. 60/711,151, filed on Aug. 24, 2005, which is incorporated herein by reference, pursuant to 35 USC 119.

### BACKGROUND OF THE INVENTION

1. Field of the Invention

The invention relates to the field of radio frequency identification devices which are orally mounted within a person.

2. Description of the Prior Art

Radio frequency (RF) technology is becoming increasingly more common in a wide variety of uses. RF technology is relatively easy to utilize and RF sensing is well developed and recognized in many areas, such as inventory control, to prevent theft, proper routing of packages or the like, etc.

As used with identifying, routing, or inventorying envelopes, packages or other containers, RF technology often utilizes labels as either the product containing the RF technology, or in association therewith. For example as shown in U.S. Pat. No. 5,497,140 a label (such as a postage stamp or a mailing label) is provided having a radio frequency identification (RFID) device and system mounted between opposing faces of the major surfaces of the label. An RFID chip is electrically connected to an RF antenna that is contained with, or is part of, the label, thereby allowing the label to be simply applied to an envelope or package in order to provide proper tracking.

Further, Motorola has introduced wireless smart label technology using “BiStatix.™. Smart Labels” to efficiently track mail containers. A typical BiStatix.™. label is approximately four inches by four inches, and contains both the antenna and the chip, and has a read or sensing distance of about one meter (that is the RF transceiver sensor must be within one meter of the labeled package in order for proper sensing). While this technology is very useful, there are many situations in which it is desirable to allow sensing at greater distances and/or perhaps with better accuracy, and with less chance for interference, and to do so in a simple and cost effective manner.

An RFID transponder can be either an active transponder or a passive transponder. An active transponder has its own internal battery and hence an increased response range, whereas a passive transponder does not have its own internal battery and generates its required power through electromagnetic coupling to an interrogation field. Passive transponders are generally less expensive than active transponders. One traditional drawback of RFID systems which include passive transponders has been their relatively limited read range (i.e., relatively limited interrogation zone). However, there are major efforts underway to increase the reading range of passive RFID tags in order to make it possible to detect the tags at increasing distances from the readers.

### BRIEF SUMMARY OF THE INVENTION

The illustrated embodiment of the invention is an apparatus for tracking a subject, such as a person or animal, comprising an RFID transponder or chip attached to a tooth of the person or animal and a transceiver in at least periodic communication with the RFID chip.

The RFID chip is attached to a buccal surface of the tooth by dental adhesive or is attached to the tooth by disposition within a cavity defined in the tooth.

The apparatus further comprises a plurality of RFID chips corresponding to a plurality of persons, the plurality of RFID chips in communication with the transceiver.

The apparatus further comprises a tracking system coupled to the transceiver to generate a warning alarm, when the person goes beyond the specified radius. The tracking system includes a display screen and upon generation of the alarm displays relevant data on the display screen. A unique frequency code is dedicated to each of the plurality of persons. The tracking system generates an alarm to designated security personnel at a remote location. The tracking system indicates a predicted exit path of the person at the time of removal.

Additionally, the microchip possesses a live tracking system, similar to the one used in certain government buildings and other high security locations, to track the exact live movements of the individuals. This can also be incorporated with a global positioning system which allows for fast tracking of the subject.

The illustrated embodiment also includes a method for operating an apparatus as described above.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The invention can be better visualized by turning now to the following drawings wherein like elements are referenced by like numerals.

### BRIEF DESCRIPTION OF THE DRAWINGS

FIG. 1 is a diagram of the environment in which the invention is used.

The invention and its various embodiments can now be better understood by turning to the following detailed description of the preferred embodiments which are presented as illustrated examples of the invention defined in the claims. It is expressly understood that the invention as defined by the claims may be broader than the illustrated embodiments described below.

### DETAILED DESCRIPTION OF THE PREFERRED EMBODIMENTS

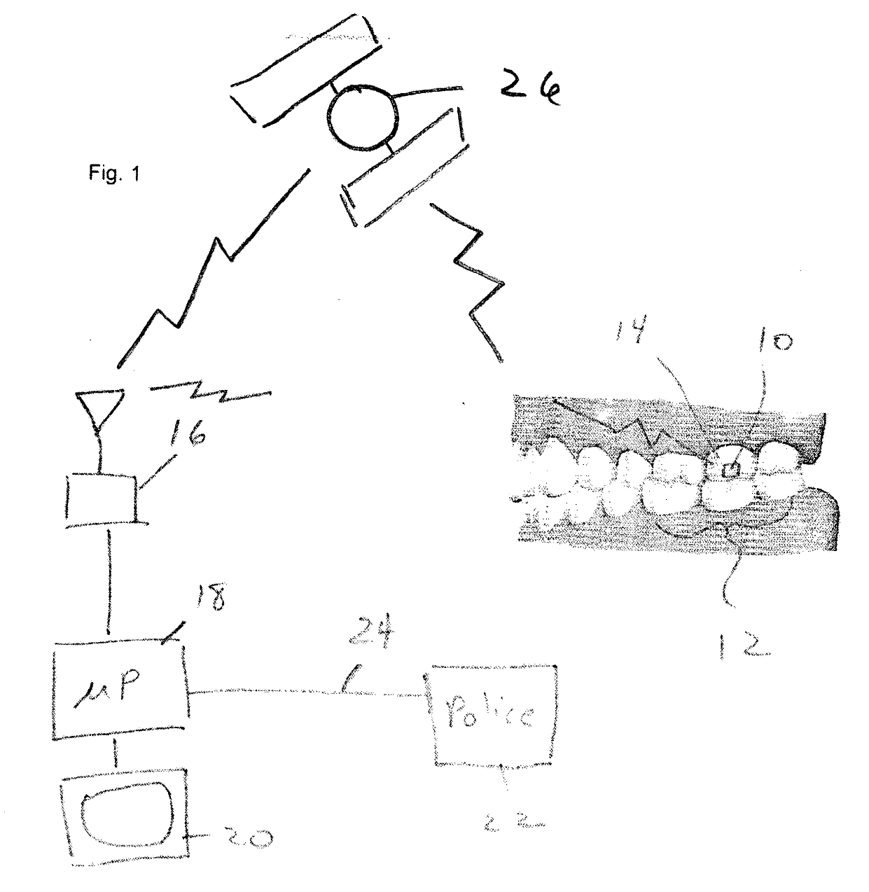

The illustrated embodiment of the invention is labeled with the coined phrase, Pedo Chip™ and as diagrammed in FIG. 1 utilizes the properties of a conventional RFID (radiofrequency identification) chip 10 small enough to be attached to the surface of the subject's or child's molar 12 by a dentist or other practitioner. Both active and passive chips 10 are contemplated as being within the scope of the invention. In one embodiment using an active chip 10 the power source is an array of microfabricated or MEMS thermoelectric generators, which draw their power or a trickle charge to a microfabricated battery from the difference in tissue temperature on the cheek and the teeth. One such power source is designed by Biophan of West Henrietta, N.Y. and is disclosed in U.S. Pat. No. 6,640,137, which is incorporated herein by reference. One purpose of the illustrated embodiment is to prevent child abduction or other loss and to make immediate tracking and isolation of the child and the probable abductor, very easy and quick. The invention can also be used to track the location of persons in high security environments or to monitor the movements of Alzheimer patients. The invention can be further employed to track the movement of animals in applications of both domestic animal husbandry and wildlife management. The illustrated embodiment will be described in connection with the use on children, but all of the above uses should be understood as being expressly included within the scope of the invention.

RFID chip 10 is small enough to adhere to the buccal (cheek) surface 14 of the lower primary first or second molars 12 of children from the age of 18 months to 6 years. At later ages chip 10 could be adhered to the buccal surfaces 14 of the permanent first molars 12. A conventional transceiver 16 is provided which is capable of picking up the RF impulses of the RFID up to a radius if 500 meters or farther. The transceiver 16 can be operated to be in constant or periodic communication with RFID chip 10, which is adhered to the buccal surface 14 of the molar 12 of the child with a strong, conventional dental adhesive. The communication may be multiplexed, pulsed or formatted in any communication mode now known or later devised. It is contemplated that chip 10 will be periodically polled, such as several times a second or at least once every few seconds.

In the case of inclusion of chip 10 within a satellite system, transceiver 16 may operate in combination with a GPS system 26 to assign a geographic location to the subject. Direct communication between chip 10 and a GPS system is also contemplated where chip 10 is capable of generating a signal of sufficient strength. Implanted subdermal GPS tracking devices are manufactured by Applied Digital Solutions of New York, N.Y. under the VeriChip™ trademark and utilize connections to cellular telephone systems to relay the satellite determined position of its tracked host to a central station.

The RFID chip 10 can also be placed inside of a drilled cavity on the buccal surface 14 of the molar 12, if the parents of the child so desire. Otherwise it can be simply glued to the tooth surface 14. The antenna for chip 10 may be molded onto the tooth, similar to a filling or may in fact serve as or be incorporated into a filling.

The illustrated embodiment of the invention is especially designed for school facilities or any facility where there are large gathering of children or subjects without close or constant direct supervision. One main transceiver 16 is coupled to a conventional tracking system 18 such as a personal computer in a main location with at least one person in close proximity or in communication with the tracking system 18, who to be able to see and hear or otherwise become aware of a warning alarm generated by tracking system 18, when a child or subject goes beyond the specified radius. Upon generation of the alarm, tracking system 18 displays the relevant data on a display screen 20, which shows for example the child's name, the date and time of loss of contact, the direction or position where contact was last obtained, names and locations of supervisory personnel responsible for the child at the moment or closest to the child's last known location, names and contact information of the parents or guardians of the child, emergency contact information and the like.

In the illustrated embodiment each RFID chip 10 operates on a unique dedicated frequency or a single frequency which is time-multiplexed so that each child will have its own exclusive individual numeric code. However, it is to be understood that many communication modes and/or codings may be employed which allow unique identification of one of a multiplicity of chips 10 in a given area. Once the child arrives at school or the facility, the chip 10 is activated automatically or tracked by system 18 and will remain activated or in at least periodic communication until it is deactivated or released from system 18 by an authorized person via a deactivating remote device, i.e. when the child is ready to be picked up be authorized adult from school in the afternoon.

In the event that the child moves beyond a designated radius, the transceiver 16 and tracking system 18 will alarm the people monitoring the tracking system 18 and if not acknowledged, it will also alert the police or other security personnel at a remote station 22 through a phone line 24 or other communication link within a designated period of time as well as the family or legal guardians of the child, if they so desire, via a modem, pager, cell phone or work phone. The school authorities and the police or other security personnel at station 22 will also have immediately available to them the complete identity of the child, which was pre-registered at the time of placement of the RFID chip 10. The information is then entered into a secure central information bank at station 22.

It may be appreciated that the time that it takes for the parties to be notified from the moment the child is removed beyond the designated radius is only few seconds. After which time the child can be tracked by the authorities or the responsible parties via a conventional portable transceiver (not shown) which indicates the predicted exit path of the child at the time of and after removal, and his/her whereabouts. For example, the details of the area in which the child is present is prestored in tracking system 18, so that-upon generation of an alarm signal signifying that the child has exited the area, the most probably exit paths can be displayed. When locational information is also available through a GPS system 26 or terrestrial direction finder system, it is also to program tracking system 18 so that it makes its exit path prediction as a function of the last known position of the child within the monitored area. When tracking system 18 is portable, it is also possible to use it as a means for tracking the child's actual location and path after generation of the initial alarm, or as a means of proximity searching probable locations for the child.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following invention and its various embodiments.

For example, although the illustrated embodiment describes the use of a conventional RFID chip 10, it is also contemplated that any kind of responder now known or later devised which can be orally mounted can be employed. The chip 10 or responder may be inductively or passively powered or may include a microminiaturized power source to allow longer range detection and response.

Further, although the illustrated embodiment is described in terms of tracking children it can be applied with equal efficacy to any person or animal. It is anticipated that the invention will be of utility with adult Alzheimer patients, who may have a tendency to wander. Also the invention may be used in custodial or security arrangements to track prisoners or parolees in a less intrusive manner than ankle bracelets.

Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the invention is explicitly contemplated as within the scope of the invention.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the invention.

I claim:

1. An apparatus for tracking a subject comprising:
an RFID chip attached to a tooth of the subject; and
a transceiver in at least periodic communication with the RFID chip.

2. The apparatus of claim 1 where the RFID chip is attached to a buccal surface of the tooth by dental adhesive.

3. The apparatus of claim 1 where the RFID chip is attached to the tooth by disposition within a cavity defined in the tooth.

4. The apparatus of claim 3 where cavity is defined in a buccal surface of the tooth.

5. The apparatus of claim 1 further comprising a plurality of RFID chips corresponding to a plurality of subjects, the plurality of RFID chips in communication with the transceiver.

6. The apparatus of claim 1 further comprising a tracking system coupled to the transceiver to generate a warning alarm, when the subject goes beyond the specified radius.

7. The apparatus of claim 6 where the tracking system includes a display screen and upon generation of the alarm displays data relating to the subject on the display screen.

8. The apparatus of claim 5 where a unique frequency code is dedicated to each of the plurality of subjects.

9. The apparatus of claim 6 where the tracking system generates an alarm to a designated security monitor at a remote location.

10. The apparatus of claim 6 where the tracking system is employed to indicate a predicted exit path of the subject at the time of removal.

11. The apparatus of claim 10 where the tracking system is portable to track an actual exit path of the subject after the time of removal.

12. The apparatus of claim 1 where the RFID chip and transceiver are arranged and configured for operation within a global positioning satellite system for determining geographical location of the subject.

13. A method for tracking a subject comprising:
attaching an RFID chip to a tooth of the subject; and
at least periodically communicating with the RFID chip to determine locational information pertaining to the subject.

14. The method of claim 13 where attaching the RFID chip to the tooth of the subject comprises adhering the RFID chip is attached to a buccal surface of the tooth with a dental adhesive.

15. The method of claim 13 where attaching the RFID chip to the tooth of the subject comprises defining a cavity in the tooth and disposing the RFID chip into the tooth within the cavity.

16. The method of claim 13 further comprising generating a warning alarm, when the subject goes beyond the specified radius.

17. The method of claim 16 further comprising uniquely identifying the subject from identification data read from the chip and automatically displaying personal and security data relating to the subject upon generation of the alarm.

18. The method of claim 16 further comprising predicting an exit path of the subject at the time of removal from a predetermined area.

19. The method of claim 18 further comprising tracking an actual exit path of the subject after the time of removal.

20. The method of claim 13 further comprising determining a geographical location of the subject by using a global positioning satellite system in combination with the chip.
